(19) United States
(12) Patent Application Publication
(10) Pub. No.: US 2026/0010649 A1
(43) Pub. Date: Jan. 8, 2026

(54) SYSTEM AND METHOD FOR TRANSMITTING ALERTS OVER A COMPUTER NETWORK

(71) Applicant: Morgan Stanley Services Group Inc., New York, NY (US)

(72) Inventors: Chirag KARKERA, Mumbai (IN); Dipali ACHARYA, Mumbai (IN); Kayan KATRAK, Bangalore (IN); Shubham TANDON, Kanpur (IN); Harsh AJMERA, Gujarat (IN); Abira GANGULI, Maharashtra (IN); Chaitya CHHEDA, Mumbai (IN)

(73) Assignee: Morgan Stanley Services Group Inc., New York, NY (US)

(21) Appl. No.: 18/763,325

(22) Filed: Jul. 3, 2024

(51) Int. Cl. G06F 21/62

(52) U.S. Cl. CPC G06F 21/6245

(57) ABSTRACT

A system and method may provide network communication protocols for handling emergencies while keeping private information secure. Some embodiments may include using a computer processor of a computerized sever to extract data items to be exchanged based first information items, where the first information items are received from a sender computing device; determining a mode of communication based on second information items—where the second information items describe destination computing devices; and transmitting the extracted data items to destination computing devices device based on the determined mode of communication. In some embodiments, some of the information items may describe or may be associated with a third entity or device, which may be a device separate from the sender computer and from the server.

### FIELD OF THE INVENTION

The present invention relates generally to data network communication protocols, and more specifically to communication protocols for emergency alerts.

### BACKGROUND OF THE INVENTION

Emergency communication protocols are established procedures and guidelines designed to facilitate effective communication during crises, failure, and emergencies. They may, e.g., outline the steps to be taken, the channels to be used, and the entities involved in disseminating critical information, coordinating response efforts, and ensuring safety for entities associated with the emergency (which may be for example human beings experiencing a medical emergency or crises, as well as computer systems experiencing hardware or software failures). Emergency protocols are essential because they may help to streamline coordination, and expedite decision-making in high-stress situations. By ensuring that relevant information reaches the right destinations at the right time, emergency communication protocols may play a crucial role in mitigating the impact of disasters, saving lives, and protecting property.

Many technologies for the handling of emergencies rely on manual communication procedures and fragmented communication channels, often leading to delays and miscommunication during critical moments. There is therefore a need for computerized protocols to offer to streamline emergency communications while leveraging the power of technology to enhance coordination, efficiency, and effectiveness in response efforts—as well as to provide desirable features such as, e.g., data privacy.

### SUMMARY

A system and method may provide a robust technological framework for performing computerized network communication protocols while keeping private information secure. Some embodiments of the invention may include using a computer processor of a computerized sever to extract data items to be exchanged based first information items, where the first information items may be received from a sender computing device; determining a mode of communication based on second information items—where the second information items may describe destination computing devices; and transmitting the extracted data items to the destination computing devices device based on the determined mode of communication.

In some embodiments, some of the information items may describe or may be associated with a third entity or device, which may be a device separate from the sender computer and from the server.

In some embodiments, the determining of a mode of communication, the transmitting of the extracted data items, and/or additional computerized operations or protocols may be performed based on an exchange type, where the exchange type may be generated and/or updated using a GUI of an administrator device.

Some nonlimiting example data structures, as well as nonlimiting example use cases relating to medical emergencies are provided; different embodiments, however, may relate to strictly technological or computerized environments involving network communication and including no human users. Nonlimiting examples relating to failure in computer resources are provided as well.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals may indicate corresponding, analogous, or similar elements, and in which:

FIG. 1 is a high-level block diagram of an exemplary computing device which may be used with embodiments of the present invention;

FIG. 2 shows example computer systems remotely connected by a data network according to some embodiments of the invention;

FIG. 3 is a block diagram showing an example system for performing emergency network communication protocols according to some embodiments of the invention;

FIG. 4 shows example workflows for performing an emergency network communication protocol according to some embodiments of the invention;

FIG. 5A-C shows an example user interface for performing an emergency network communication according to some embodiments of the invention;

FIG. 6 shows example notifications which may be sent in example emergency communication protocols according to some embodiments of the invention;

FIG. 7 shows an example admin page and corresponding example emergency communication settings according to some embodiments of the invention;

FIG. 8 shows example code and data structures for an emergency communication according to some embodiments of the invention;

FIG. 9 shows an example user registration process according to some embodiments of the invention; and

FIG. 10 shows an example method for performing exchanges of data over a computer network according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, components, modules, units and/or circuits have not been described in detail so as not to obscure the invention.

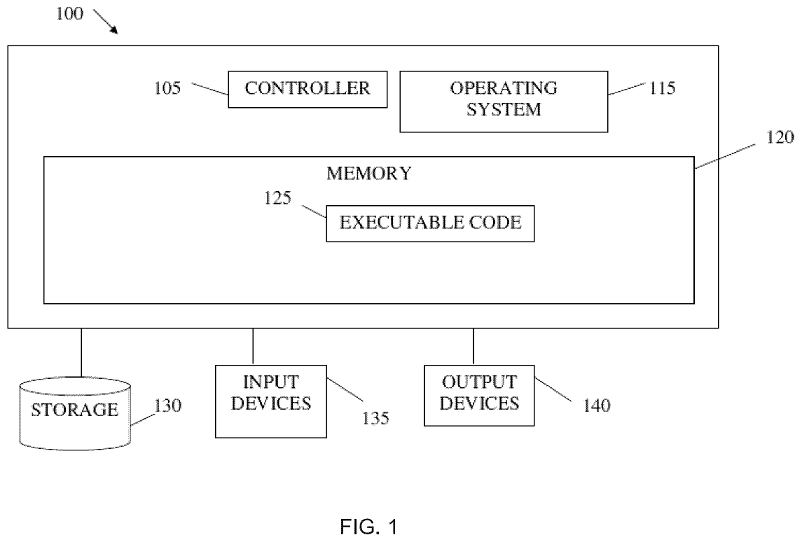

FIG. 1 shows a high-level block diagram of an exemplary computing device which may be used with embodiments of the present invention. Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. Memory 120 may be or may include a plurality of different memory units. Memory 120 may store for example, instructions (e.g. code 125) to carry out a method as disclosed herein, and/or output data, etc.

Executable code 125 may be any application, program, process, task, or script. Executable code 125 may be executed by controller 105 possibly under control of operating system 115. For example, executable code 125 may be or execute one or more applications performing methods as disclosed herein. In some embodiments, more than one computing device 100 or components of device 100 may be used. One or more processor(s) 105 may be configured to carry out embodiments of the present invention by for example executing software or code. Storage 130 may be or may include, for example, a hard disk drive, a floppy disk drive, a compact disk (CD) drive, a universal serial bus (USB) device or other suitable removable and/or fixed storage unit. Data described herein may be stored in a storage 130 and may be loaded from storage 130 into a memory 120 where it may be processed by controller 105.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods and procedures disclosed herein.

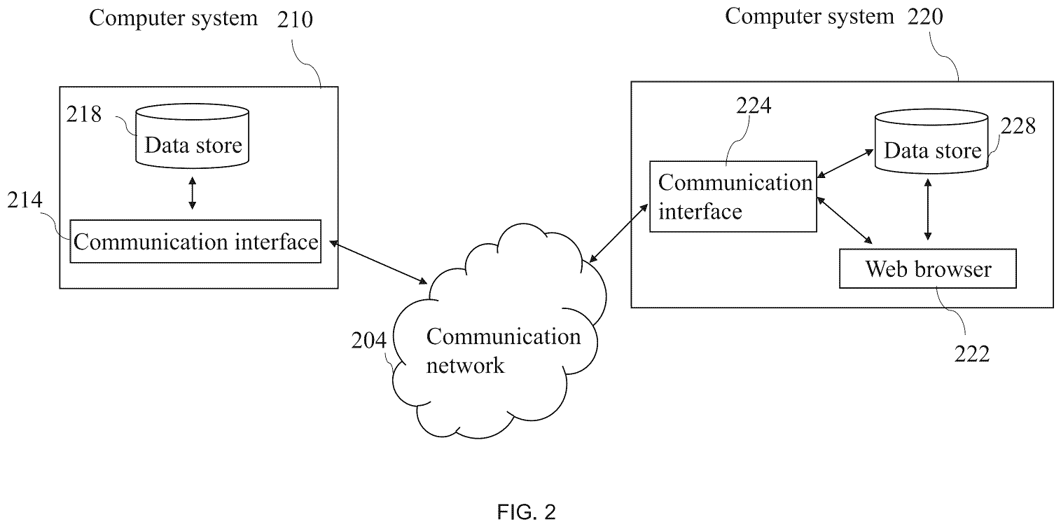

FIG. 2 shows example computer systems remotely connected by a data network according to some embodiments of the invention.

Some embodiments of the invention may include performing an exchange of data or data transfer between remotely connected computer devices. For example, remote computer 210 may send or transmit, over communication or data network 204, computerized data items or data points of information—to computerized system 220, and/or vice versa. Each of systems 210 and 220 may be or may include the various components described with reference to system 100, as well as other computer systems, and include and/or operate or perform, e.g., the various corresponding protocols and procedures described herein. In some embodiments, computerized systems 210 and 220 may additionally perform a plurality of operations including for example sending and/or transmitting and/or collecting and/or receiving additional data to or from additional remote computers systems. One skilled in the art may recognize that additional and/or alternative remote and/or computerized systems and/or network and connectivity types may be included in different embodiments of the invention.

In some embodiments of the invention, computer systems 210 and 220 may communicate via data or communication or data network 204 via appropriate communication interfaces 214 and 224, respectively—which may be for example NICs or network adapters as known in the art. Computerized systems 210 and/or 220 may include data stores such as, e.g., 218 and 228 which may for example include a plurality of received data items, messages, requests, reports, and the like, such as for example described herein.

A “server”, “destination”, “user”, “employee”, or “colleague” as used herein may refer, e.g., to computer systems or resources (such as for example ones described with regard to FIGS. 1-2) or to computerized or mobile devices which may or may not be operated by humans, and which may be communicating using a data or cellular network—for example according to the various protocols and procedures described herein. While some example embodiments described in the present disclosure may relate to medical emergencies—different emergency protocols according to some embodiments may relate to computerized and/or hardware resources. Example embodiments relating to medical emergencies should thus be considered as nonlimiting.

Embodiments of the invention may provide a standardized framework and/or platform for managing and/or performing emergency communication protocols.

Some embodiments of the invention may improve communications and data transmission technology by reducing communications time in emergency contexts, and reducing overall response times for handling emergencies, such as for example emergencies taking place at a workplace. Some embodiments may therefore provide a standardized and efficient electronic communications framework and protocols for communications used when handling emergencies which may, e.g., replace inefficient and cumbersome solutions (which, for example, were not specifically designed for handling emergencies) and thus save lives and/or prevent harm or failure in computerized systems.

Some embodiments may consolidate and/or store and/or manage all emergency related data or information items using a single platform or service, which may include or may be implemented in a plurality of systems and/or methods such as for example described herein.

As used herein, private or sensitive data and/or information items may encompass data that an individual wishes to keep confidential, typically relating to personal aspects of their life such as their identity, health condition, and the like- or data kept in a computer system that is not intended to be shared or exchanged with other devices or systems. Personally Identifiable Information (PII) may refer to specific data that can uniquely identify an individual or computer system, such as a name, social security number, address, phone number, email address, or biometric data—as well as internet protocol (IP) address, serial numbers, passwords, secret files, credentials, and the like. PII may highly sensitive and requires strict protection to prevent unauthorized access or misuse, as its exposure can lead to identity theft, financial fraud, or breaches of privacy. Some embodiments of the invention may improve technology by ensuring data security and confidentiality, e.g., as part of some of the example communication operations and/or protocols described herein—thereby preventing fraud or mitigating fraud risks.

A technological framework or computerized platform for emergency communication according to some embodiments of the invention may be referred to as the “ICE” framework or platform, or simple as ICE.

An emergency as used herein may refer to, in addition to the occurrence of a dangerous or urgent condition, a plurality of data structures or elements, and/or to relationships between data structures or elements, and/or to a plurality of computerized communication operations and/or a communication protocol performed based on data structures or elements such as for example described herein. “Raising an emergency” as used herein may refer to triggering or initiating an emergency communication protocol such as described herein—for example by a user clicking on a dedicated button or icon on a user interface (e.g. providing input to a computer), or by a computer system detecting a malfunction and automatically sending a network message to a corresponding server, which may be managing or performing some or all of the operations further described herein.

As used herein, a “sender computing device” or “initiator device” may for example refer to the computer system requesting or initiating an emergency communication protocol such as for example described herein; a “computerized server” or “server” may for example refer to a system managing or performing computerized operations based, e.g., on data items stored in databases and/or on communication initiation by the sender or initiator computer such as for example described herein; a “destination computing device” or “target computing device” may for example refer to a computing device that may receive data items, or to which data items may be sent, transferred, or transmitted, for example by the server such as for example described herein, and which may be responsible for handling or resolving the emergency, and/or for performing automated computerized actions such as for example described herein; a “third entity” or “a third computing device” as used herein may for example refer to a computing device associated with or described by the emergency raised, e.g., by the sender computing device (in one example, the third computing device may be that of a colleague, for which a sender computing device may raise an emergency, such as for example in case the colleague may not be able to raise an emergency for themselves and/or in case the third computerized device is inaccessible or inoperable, such as, e.g., described herein).

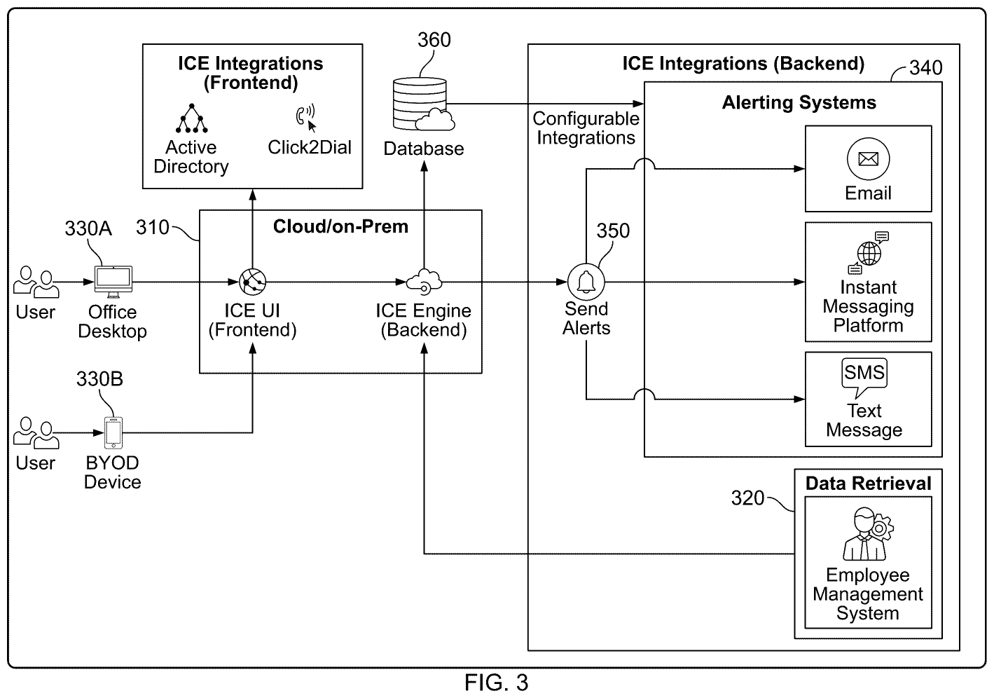

FIG. 3 is a block diagram showing an example system for performing emergency network communication protocols according to some embodiments of the invention.

Some embodiments of the invention may be deployed as a web application or platform 310 for example in a distributed cloud computer system or server, and/or on premise—using a centralized server or computer system. Example web applications may be referred to as the “ICE application” or simply “ICE” herein.

Some example embodiments may be integrated into existing workforce management (WM) systems or platforms 320 (such as for example the Workday platform, although additional example WM tools or platforms may be used in different embodiments), for example using appropriate application programming interfaces (APIs)—and for example fetch or retrieve data or information items or elements from WM systems 320, e.g., according to the example protocols and/or procedures described herein.

Some embodiments may include dedicated apps or user interfaces (UIs) which may be installed on or accessed by user devices 330A-B (which may be, e.g., sender and/or third computing entities such as for example described herein), for example to allow communicating with the corresponding web or cloud application, e.g., according to the example protocols described herein. A UI or a plurality of UIs according to some embodiments of the invention may be created or generated using, e.g., the React or ReactJS content framework or library, although additional or alternative frameworks may be used in different embodiments. Some embodiments may initiate or manage emergency communication protocols, e.g., at a click on a button or pressing on an icon presented on a UIs on a relevant computer system (which may be or may include for example a desktop computer or user mobile device). In some embodiments, raising an emergency and/or additional communications between the sender device and the server may include sending network requests and commands and/or performing exchanges of data, or data transfers, over a data network, which may include, e.g., transferring data elements or data structures such as for example provided herein.

Some example embodiments may be integrated (e.g., backend integrated) with existing communication technologies, systems, or tools 340 such as for example using APIs or interfaces to the Microsoft Outlook and/or Teams platforms, the Workday WM platform, short messaging service (SMS) tools or platforms such as for example the TextMagic platform, and so forth, to perform some example emergency communications such as, e.g., described herein.

As part of some example communication protocols (such as, e.g., ones described herein) some embodiments may automatically send, transfer, or transmit a plurality of alerts and/or messages and/or notifications 350 over a data or communication network, for example from the server to a plurality of computerized systems to destination computerized systems or devices (which may, e.g., correspond to computer systems such as, e.g., systems 210 or 220)—where messages may for example be sent in “bulk”, simultaneously, or in parallel, to multiple separate and distinct destinations.

Some embodiments may include storing, maintaining, or managing a plurality of data or information elements or items (such as, e.g., data items to be exchanged or transferred, first and second information items and the like—which may be or may include for the example data items or elements provided herein, and/or according to the example protocols described herein) in a dedicated database or databases 360 associated with or remotely connected to the relevant computer system or systems on which ICE may be deployed. Some databases according to some embodiments of the invention may be referred to simply as “DB” herein.

Some embodiments may be integrated (e.g., frontend integrated) with additional platforms, applications, or services, such as for example Active Directory service by Microsoft, e.g., for access permission management (for example to distinguish between admins and non-admin users or devices, such as for example described herein) and/or the Click2Dial tool or plugin by IPTECH, e.g., for converting phone numbers into clickable links (which may, e.g., be used as part of raising an emergency, e.g., by a sender computer using a UI).

Additional or alternative components and/or integrations may be included and used in different embodiments.

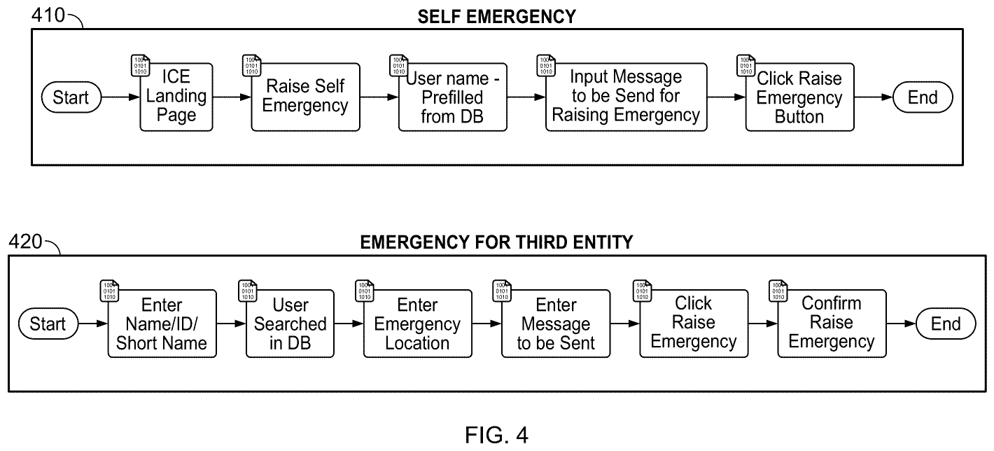

FIG. 4 shows example workflows for performing an emergency network communication protocol according to some embodiments of the invention.

Some embodiments of the invention may include extracting, by the processor, one or more data items to be exchanged based on one or more first information items. For example, data or information items such as for example provided herein may be stored, e.g., in the server's memory, and the server may search and extract, retrieve, or fetch data or information items associated with, e.g., the user or device for which an emergency is raised, for example based on the contents of the emergency alert or message received from the sender or initiator device. Some information items stored by the server (which may, e.g., be selected to be exchanged and then be extracted or retrieved and sent, transferred, or transmitted by some embodiments of the invention) may first be received over a data or communication network—for example from a user or device upon enrolling or registering into ICE (see further description herein) or from a WM application with which some embodiments may be integrated. Some nonlimiting example workflows for raising emergencies and performing network communication operations based on an emergency or emergency request or alert are further provided herein.

In one example workflow 410, a sender computerized system may initiate an emergency protocol describing, or associated with itself, the sender computer. In such an example workflow, the sender system may initiate the raising of a “self emergency” (for example by using a UI of a computer application such as for example described herein). The raising of an emergency may for example be included or implemented in a dedicated emergency or emergency request data structure or element (such as for example provided herein) and may be sent, transferred, or transmitted to the server over a data or communication network. Embodiments may then fetch, retrieve or extract a plurality of data or information items from a dedicated database based on the emergency and/or data structure received; this may include, for example, matching an identifier or field in the emergency request with a database entry. The extracted items may be for example second information items describing the sender computer system raising a self emergency (and including, e.g., a username or identifier describing the sender or initiator computer, and/or an input message, request or command—which may be prespecified or predetermined by the sender computer device and, e.g., stored in the server's memory). Following the fetching, retrieving, or extracting of data items, the sender computer may verify or confirm the raising of emergency (e.g., by clicking a dedicated button on a UI such as for example described herein). Following the confirmation, embodiments may proceed to perform additional or alternative emergency communication operations, protocols, and procedures such as for example described herein.

In a second example workflow 420, a sender computerized system may initiate an emergency protocol describing, or associated with, a third entity or computer device. In such an example workflow, the sender system may enter or specify and/or the emergency or emergency request may include an identifier or identifiers or the third entity, which may be used for example by the server to search and/or fetch, retrieve, or extract additional information items describing, or associated with, the third entity: for example, the server may input an identifier received from the sender computer into a workforce or resource management system, to extract or fetch additional details or records which may not be accessible to the sender or initiator computer, such as for example described herein. In some embodiments, the sender computer system or the server may specify a location in which an emergency is taking place—and/or a location associated with the third entity. Some embodiments may then enter or input an emergency message, request, or command—which may be prespecified or predetermined by the third entity or computer device and, e.g., stored in the server's memory, or stored in the workforce or resource management system which may be integrated with the server. The sender computer may then approve and/or confirm the raising of the emergency based on the information describing or associated with the third entity or computer system (e.g., by clicking a dedicated button on a UI such as for example described herein), and embodiments may proceed to perform additional or alternative emergency communication operations, protocols, and procedures such as for example described herein.

In some embodiments, one or more of the destination computing devices device are associated with emergency contacts, and wherein one or more of the destination computing devices device are associated with medical care providers.

A nonlimiting example application of some emergency communication protocols provided by some embodiments of the invention may relate to handling medical emergencies at a workplace. For example, a sender computer system may be associated with or operated by a given user or employee, and may for example be used according to workflow 410 to raise a medical emergency for that user or employee. In such an example, destination computer devices may be, e.g., computer systems associated with or operated by emergency care providers prespecified by the user or employee raising the emergency—to whom data items may be transmitted by embodiments of the invention such as for example described herein. In another example, the sender or initiator computer system may be used according to workflow 420 to raise a medical emergency for a user or employee different from the user or employee associated with the sender computer system (which may be for example a colleague of the user operating the sending system and/or raising the emergency, who may not be able to raise a self emergency, e.g., due to being unconscious). In such an example, destination computer devices may be, e.g., computer systems associated with or operated by emergency care providers prespecified or preselected by the colleague for whom the emergency is raised.

Additional or alternative example applications may relate to computerized resources: for example, workflow 410 may be used by a sender computer system in which a threat or malfunction is detected. A sender computer system may for example look up an executable file or data item and determine that the file is not found in a database or memory resource (which may for example prevent a computer program from running successfully). The sender may then raise an emergency, e.g., such that the server and/or destination computer systems may be aware of the sender not having access to the file or item. In another example, workflow 420 may be used, e.g., by a sender computer system which may be communicating with a third entity or computer system that may be malfunctioning: in such manner, the sender system may receive an error message from the third entity (describing, for example, a failure in executing a computer process, for example due to an executable file or item not found in the third entity or system), e.g., over a data or communication network, and may initiate and/or perform an emergency communication protocol including, e.g., a plurality of operations such as for example described herein. In some embodiments and example applications, some operations and elements (such as for example UI operations and procedures) may be omitted and/or be replaced by alternative operations and elements (for example, automated computerized actions may in some cases be used instead of a user clicking buttons, etc.).

Additional or alternative example applications of different embodiments of the invention may be realized.

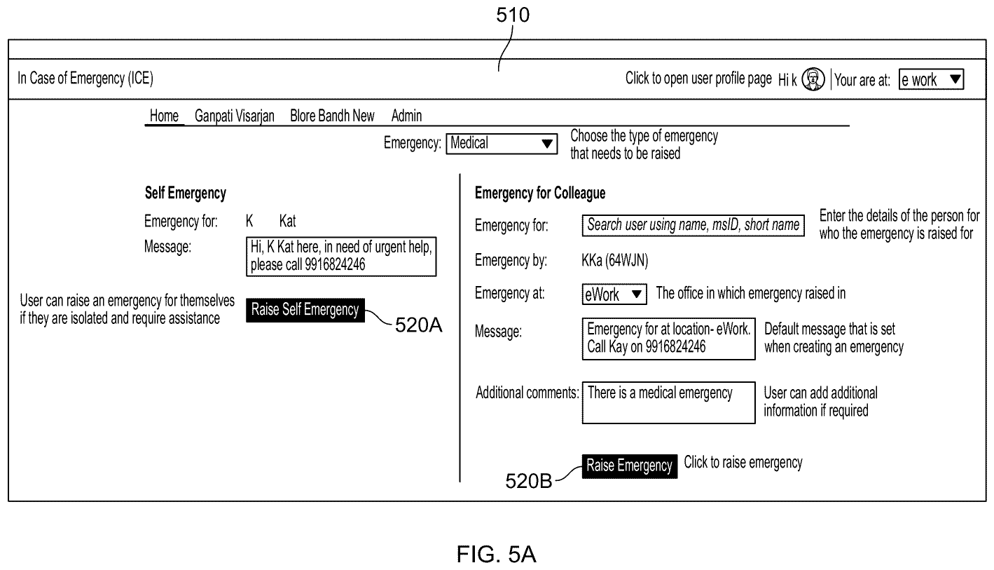

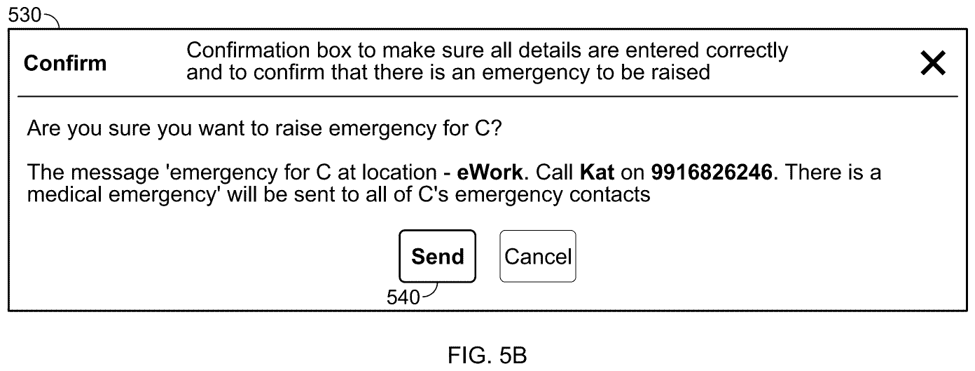

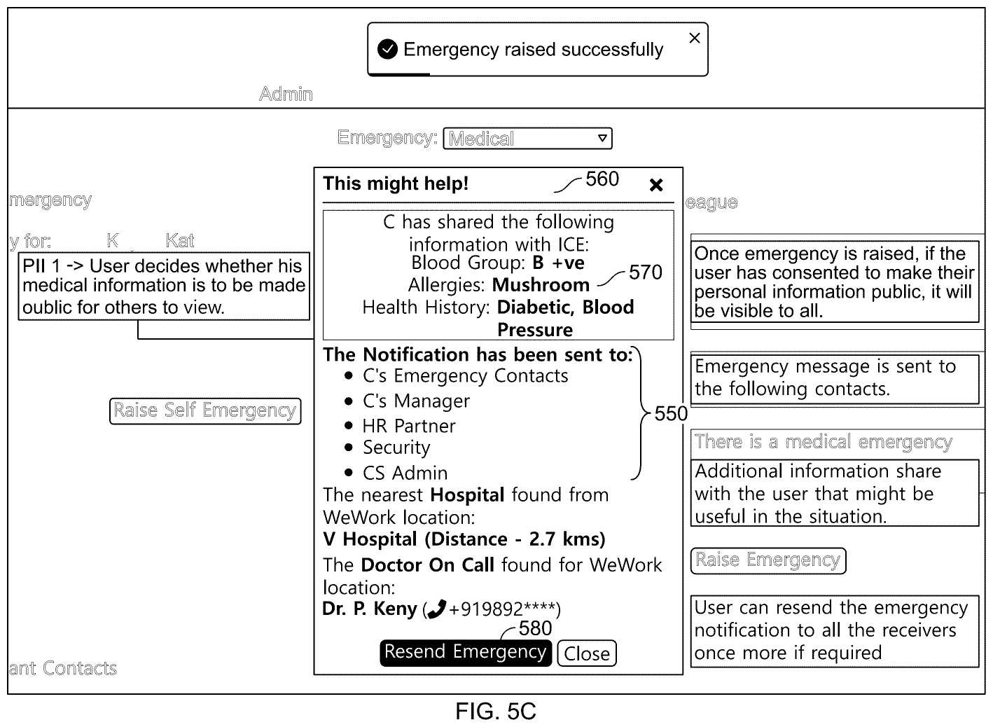

FIG. 5A-C shows an example user interface for performing an emergency network communication according to some embodiments of the invention.

When a registered user or entity logs into the ICE app or program, it may land or enter directly into home page 510. From there, the user may perform a plurality of actions such as for example view their profile on the app to make any necessary edits, or raise an emergency for themselves 520A or for another colleague 520B.

When a new (e.g., unregistered) user logs-in to ICE, the user may be redirected to a user registration page. In some embodiments, user registration may be optional, and a user may have an option to skip registration and raise an emergency for themselves or for a colleague—for example using default emergency templates or configurations or using data or information already available in the system.

In some embodiments, the extracted data items and one or more the second information items are associated with a third computing device, wherein the third computing device is offline. In some embodiments, the transmitting of the extracted data items is initiated by clicking a button on a GUI of the sender device.

For example, a user may log into ICE to raise an emergency for a colleague, who may not be able to request an emergency by or for themselves (due to, e.g., the third computing device being inoperable or inaccessible, or being offline, or to the operator of the device being unconscious, etc.). After selecting or specifying the person who they are raising an emergency for, a confirmation popup window 530 may be shown with all relevant information highlighted. To confirm, the user may click or push a “send” button 540, and notifications may be sent to a group of entities or destinations 550 as shown in a window describing the emergency raised 560.

Some embodiments of the invention may include displaying one or more of the second information items on a graphical user interface (GUI) of the sender device.

For example, if the colleague who the emergency was raised for has consented or has granted permissions to display his private information such as for example personal medical information publicly (which may for example be specified or determined by the user upon enrolling or registering to ICE), it may be visible to the user once emergency is raised along with additional useful contact information (see, e.g., element 570). In another example, access may be denied or granted to database entries or records in the server describing the computerized system for which an emergency is raised (which may, e.g., be determined by an admin, and/or based on predetermined settings, conditions and/or criteria, such as for example granting access to database records describing devices associated with a specific location, or denying access to records describing devices with another given location; additional or alternative examples for conditions or criteria may be used in different embodiments). If access is granted, it may be displayed on a GUI of the computer or device raising the emergency. Otherwise, no information item, or a different information item for which access may be granted, may then be displayed. Additional or alternative examples may be used in different embodiments.

In some embodiments, the user may resend the emergency which will again send the notifications out to the group of people, e.g., by clicking a “resend” button 580.

Additional or alternative elements may be included in user interfaces according to different embodiments of the invention.

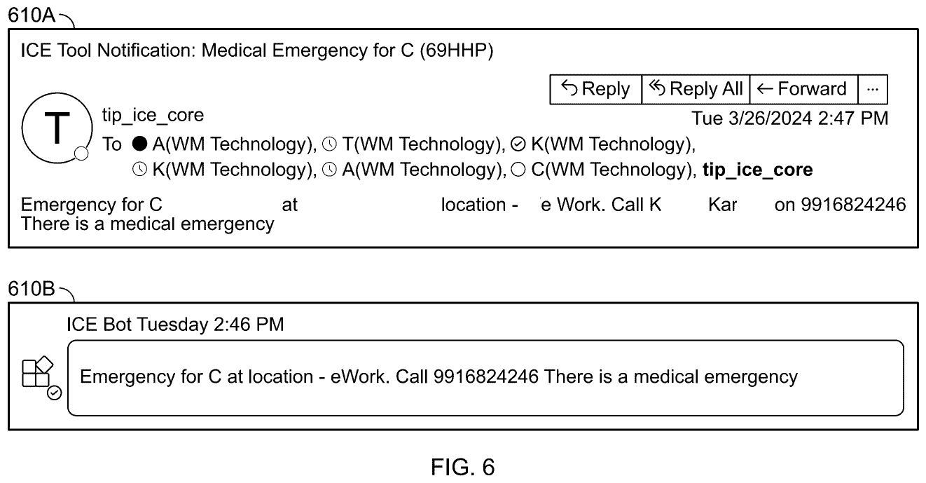

FIG. 6 shows example notifications which may be sent in example emergency communication protocols according to some embodiments of the invention.

Some embodiments may automatically send notifications or alerts 610A-B using dedicated channels and/or services—for example according to modes of communication or configurations determined, specified, or selected by relevant entities such as for example described herein.

In some embodiments, the mode of communication comprises at least one of: an SMS, and an email notification.

In one nonlimiting example, some embodiments may send email notifications 610A which may include a predetermined or prespecified text message. In another example, some embodiments may send notifications or alerts 610B (which may be for example SMS messages or alerts) using a dedicated bot, which may for example be integrated or be used with an instant messaging service or platform such as for example the WhatsApp messaging platform, or a separate, and/or custom messaging service or platform on ICE.

According to some embodiments, a text message may, e.g., be a default emergency message or template such as, e.g.: “Emergency for [name] at [location]. Call [emergency contact name] at [emergency contact number]; there is an [emergency type]”, or a custom message determined, specified, or selected by a relevant entity (for example a sender computer, or a third entity or user for which an emergency is raised) and may for example be stored in a corresponding database of the server and be used once an emergency is raised. Upon the raising of an emergency, some embodiments may for example look up an emergency message database to check if there is an emergency message matching an identifier describing the entity for whom an emergency is raised (see, e.g., identifiers described herein). If there is one (namely, e.g., if the third entity has entered a custom message to be used in cases of emergency)—embodiments may automatically copy and paste this message from the database and use it to send notifications to emergency contacts or destinations. Otherwise, if no message is matching the identifier in the emergency message database, embodiments may use and/or send a default message.

Additional or alternative notifications/messages/alerts and/or their contents may be used and/or sent or transmitted by different embodiments of the invention.

Embodiments of the invention may provide a plurality of data and information workflows or flows as part of emergency communication protocols.

“First information items” or “first data elements” as used herein may for example refer to data or information items received from a sender computing device—from which a request for an emergency communication protocol may be sent and which may be initiating an emergency communication protocol such as for example described herein. “Second information items” or “second data elements” as used herein may for example refer to data of information items stored in DB and for example describing destination computing devices (which may for example be associated or be received from the sender computing device and/or from the third entity or device). Additional or alternative data and/or information items, as well as classifications of these data items, may be used in different embodiments.

An example workflow according to some embodiments, considering a user (which may be e.g., a sender device or computer system used for raising a given emergency) already registered to ICE:
Embodiments may pass or transmit communication data items and/or information details such as, e.g., first information items or elements including a sender or initiator ID (which may be, e.g., an identifier describing a sender computing device, or the user raising the emergency), a “for” ID (which may be, e.g., an identifier describing the user for whom the emergency is raised), a “name” field (describing, e.g., the user for whom the emergency is raised), an emergency ID (e.g., an identifier describing the emergency or communication, such as for example a serial number of the emergency among a plurality of emergencies which, e.g., have already been performed), and a location ID (e.g., an identifier describing a location corresponding to where the emergency has occurred). In some embodiments, details may be passed or transmitted using an API call which may be received by the ICE platform and/or an HTTP POST method such as for example: API Call->Emergency/SendEmergencyMessage (using the HTTP POST method), which may be performed for example using a sender device or computing device raising the emergency. In some embodiments, the ICE system or platform may receive API calls or be called using an API, e.g., by a UI operated by a user or entity such as for example described herein. In some embodiments, the API layers or endpoints of ICE (see also additional discussions herein) may be built using the .NET framework or environment, although additional or alternative frameworks may be used in different embodiments.
Embodiments may validate all the details sent or transmitted when an emergency is raised. An example validation procedure according to some embodiments may be or may include, e.g.:
   1) Checking if an emergency identifier is received with the emergency, and if so, whether it exists in relevant databases; if so, embodiments may proceed to the next step; otherwise embodiments may for example create such an emergency identifier and store it in a new data structure describing the emergency such as, e.g., described herein, before proceeding to the next step.
   2) Checking if the emergency associated with the relevant identifier is valid or, e.g., if the identifier is invalid or expired. If the emergency or identifier is valid, embodiments may proceed to the next step. Otherwise, the process may terminate, or a new identifier may be created and be associated with the emergency under consideration, and the process may proceed to the next step.
   3) Checking or verifying that the user, entity, or device raising the emergency exists or is enrolled in relevant databases or data structures (such as for example ones provided herein). If so, embodiments may proceed to the next step. Otherwise, the process may terminate or may be suspended, and some embodiments may for example send a request or link to the sending user or device to enroll to ICE, e.g., according to the description herein.
   4) Checking that an identifier or the user, entity or device for whom an emergency is raised is valid and that it exists in relevant databases or systems such as for example described herein. If so, some embodiments may proceed to process and execute the emergency such as for example according to the various operations described herein. Otherwise, the process may terminate or may be suspended, and for example send a request to the device raising the emergency, asking for more information and/or for information to be corrected.

Additional or alternative validation operations or procedures may be used in different embodiments.
Some embodiments of the invention may include extracting, by the processor, one or more data items to be exchanged based on one or more first information items, wherein one or more of the first information items are received from a sender computing device. For example, if validation is successful, embodiments may extract or fetch an employee's emergency contacts from a DB (such as for example Table 1 herein, which may for example denoted “ICE_EMPLOYEE”) against or based on the “for” ID or data item received from the sender computing device. Some embodiments may fetch emergency details or parameters (e.g., from a table such as, e.g. Table 3 herein, or “ICE_EMERGENCY”) such as “mode of communication” (which may be or may include, for example text/SMS, calls, and the like), “default emergency contacts” (e.g. Table 4 herein, or ICE_DEFAULT_EMERGENCY_CONTACTS) and/or additional information and/or configurations for example using the relevant emergency ID as received from the UI used for raising the emergency. In some embodiments, the extracted data items and one or more the second information items are associated with a third computing device, wherein the third computing device is offline. For example, the information retrieved, extracted or fetched by some embodiments may be for example information originally received from, e.g., the third computing device, or from a user for whom an emergency is raised. In such a scenario, the third entity or device may provide details to the server at an earlier point in time, e.g., to enable raising emergencies for that device. Additionally or alternatively, data or information items (such as, e.g., private information or information not accessible, or not to be made accessible, to a sender device different the device for which an emergency is raised) may be provided to the server by a WM application or a different application integrated into some embodiments such as, e.g., described herein—and for example be saved or stored in relevant DBs within the server as second information items such as for example described and/or provided herein.
Some embodiments may include determining, by the processor, a mode or type of communication based on: one or more of the first information items, and a plurality of second information items, wherein one or more of the second information items describe one or more destination computing devices. In some embodiments, the mode of communication comprises at least one of: an SMS, and an email notification. For example, in some embodiments, a mode of communication or mode of transfer may be determined using data or information items received from the sender computing device (including, e.g., the emergency or alert raised) and specifying a mode of communication or transfer- and/or using data items stored in DB and describing, e.g., modes of communication specified by the third entity or user. For instance, the sender computer device may choose or determine (e.g., by selecting options presented on a UI) email alerts or messages as a mode of communication or data transfer, and embodiments may send notifications or alerts via email such as for example described herein; the sender computer may choose or determine voice call or voice over internet protocol (VOIP) as a mode of communication, and embodiments may send or transmit alerts and notifications using, e.g., VoIP calls, where the contents of the message may for example be converted from text to a voice output using text-to-speech techniques; and the like. In another example, the third entity or user, or the user or entity for which an emergency is raised, may specify a preferred mode of communication or data transfer for the relevant emergency contacts: upon registering to ICE, a user or entity (e.g., the third entity) may select a mode of communication for a given emergency contact, which may be associated with the emergency contact or with an identifier of that contact, for example in databases or data structures such as for example provided herein. When an emergency is for the relevant entity (e.g., the third entity), embodiments may automatically use the mode of communication or channel specified or determined for the relevant emergency contact as documented in the relevant data structure for the entity or contact; otherwise, if no mode or channel was specified, embodiments may use a default mode or channel (such as, e.g., an email notification). Additional or alternative modes or channels of communication and determinations or specifications of modes or channels may be used in different embodiments.
Some embodiments may include transmitting, by the processor, the extracted data items to one or more of the destination computing devices device based on the determined mode of communication. For example, depending on the mode of communication fetched or determined for the emergency (and, for example, based on clicking a button on a GUI of the sender device, which may initiate the transmitting of data), embodiments may perform or execute a communication protocol and for example send an SMS, an email notification or alert, a Microsoft Teams message, and the like, to the relevant destinations or contacts determined for the emergency. In some embodiments, multiple communication modes or protocols may be performed for a single emergency.
The configuration for the connection between ICE and different communication channels may be fetched or received from, e.g., a database such as Table 5 herein which may be referred to as “ICE_CONFIG”. In some embodiments, a configuration or “config” specifications may be or may include for example URLs for integrations with relevant communication channels such as for example the Microsoft Teams platform, as well as with email servers including for example simple mail transfer protocol (SMTP) Host/Port specifications. Additional or alternative configurations or settings may be used in different embodiments.
After messages are sent, embodiments may save the audit or communication details in a dedicated table or database (e.g., Table 4 herein, or “ICE_TRANSACTION”)

An example workflow according to some embodiments, considering, for example, a user or sender device unregistered to ICE:
When the screen is loaded or ICE is opened for the first time (e.g., by a user or sender device), embodiment may fetch the details of the user (e.g., from a workforce or resource management or WM system or platform). For example, the server (using, e.g., a dedicated ICE engine) may connect to an employee management system or WM such as for example described herein, and may receive or fetch details such as for example contact details, and/or validate that the relevant user or entity exists or is listed in a relevant database such as for example described herein, and the like. Embodiments may save or store those details for example using, e.g., a UI cache. In some embodiments, this may be done using an API call which may sent by a UI and may be received by the ICE platform such as for example according to the description herein, such as for example: API Call->Home/IsUserEnrolled/msid (using, e.g., the HTTP GET method).
Embodiments may pass, send, or transmit details and/or configurations from the user device and/or relevant databases using an emergency message, such as for example described herein. Embodiments may validate the details in the emergency message and may accordingly fetch or receive emergency contacts, details, and configurations from relevant databases, such as, e.g., described elsewhere herein. Embodiments may then perform or execute a communication protocol based on the mode of communication corresponding to the emergency at hand, and audit or communication details may then be saved or stored by embodiments of the invention.

Additional or alternative workflow steps and/or operations may be used in different embodiments of the invention.

In some embodiments, personal identifying information (PII) may not be displayed or be accessible to the user raising the emergency. For example, a sender device raising an emergency for a third entity or device may not be exposed to sensitive information of the third entity—which may for example be stored in the server and include, e.g., emergency contacts and their information, and/or private records (such as for example medical records, as described herein). Contact information may thus be handled by the server or ICE engine according to relevant data configurations or database entries (see further discussion herein) which may allow maintaining data privacy. Some embodiments of the invention may accordingly improve emergency communication technology by providing a standardized framework for emergency communications which uses private information (e.g., of the entity for which an emergency is raised) while keeping private information safe and inaccessible to unauthorized entities (e.g., the sender device or user raising the emergency).

In some embodiments, emergencies, messages, alerts or alert templates may be dynamically defined.

For example, according to some embodiments—system administrators or admins, who may be for example a selected group of users having appropriate access credentials, may help providing or maintaining alert templates and/or alert data or settings. In some embodiments, admins may have access to an admin page or admin settings which may be used to configure the ICE application and/or data structures used by the application such as for example provided herein.

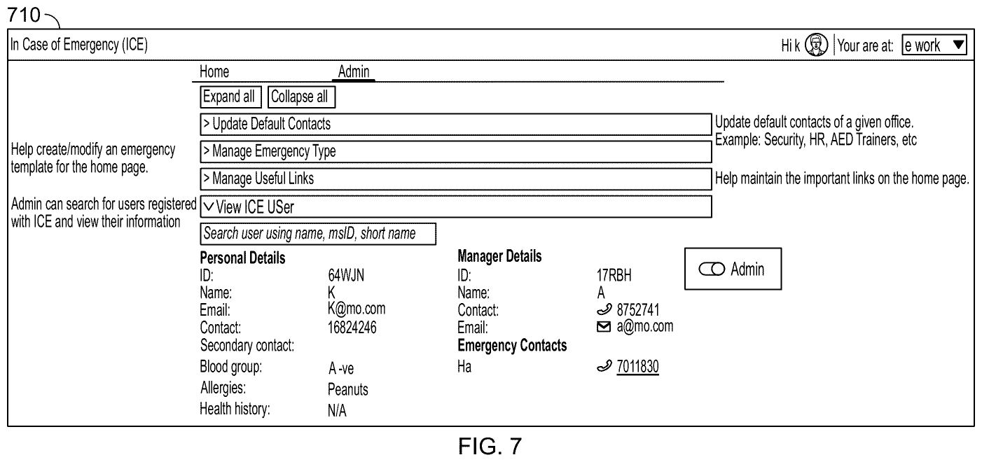

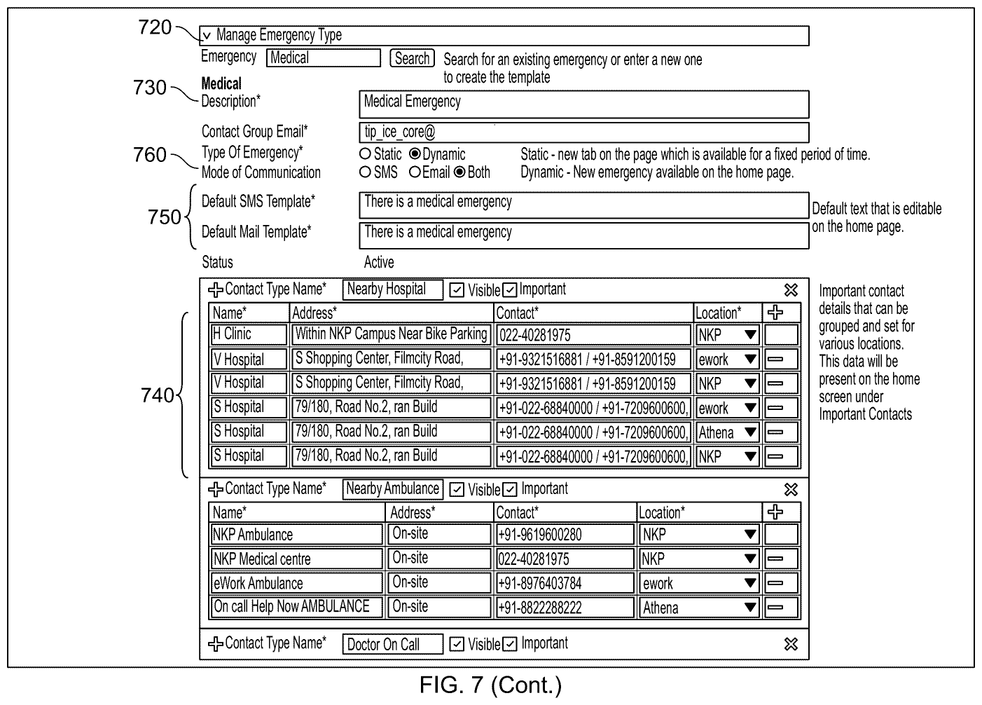

FIG. 7 shows an example admin page and corresponding example emergency communication settings according to some embodiments of the invention.

In some embodiments, the determining of a mode of communication and the transmitting of the extracted data items are performed based on an exchange type, wherein the exchange type is generated using a GUI of an administrator device.

For example, an admin may use an admin page 710 on a dedicated UI to generate, manage or change settings and/or create/modify an emergency or exchange type or template 720. In some embodiments, an admin may generate or manage emergency types to add or modify stored, template emergencies—that may then be raised or used by various users or devices using ICE. Using a dedicated UI, an admin may for example search for an existing emergency template or create one anew, e.g., from scratch. In some embodiments, emergencies or emergency templates may be stored, e.g., as dedicated files or data structures such as for example further provided herein, although additional or alternative formats may be used in different embodiments. As part of creating and/or editing emergencies, an admin may provide a plurality of settings or parameters a description or title 730 for the emergency (which may then be looked up, e.g., using a search engine as part of the admin's UI); default destination device, emergency contacts and/or contact information 740; default data items to be extracted or exchanged with destination device (such as for example default notifications, alerts or messages 750), and the like. In one nonlimiting example, an admin may change or update default destinations or emergency contacts—e.g., such that a security department or human resources department may be for example a default destination to which emergency messages or alerts may be sent. Similarly, the admin may specify modes of communication or configurations 760 to destinations, such as for example an SMS, email notification/message/alert, voice call, and the like. Once an exchange type or emergency template is created or updated and stored, a given sender device may use the newly created exchange type or template. For example, a user may select the newly created alert on a UI of ICE such as for example described herein, and may raise an emergency using the newly created alert. The server may accordingly select or extract data items to be exchanged (e.g., from first information items, or the items received from the sender computer including for example the emergency request or alert raised—or from second information items stored in the server's memory or DB and including, e.g., a default alert or message), and/or determine a mode of communication, and/or perform additional communication operations such as, e.g., described herein, based on the settings or parameters specified or determined for that exchange type or template. Additional or alternative example admin UIs and/or nonlimiting use case examples may be provided by different embodiments of the invention.

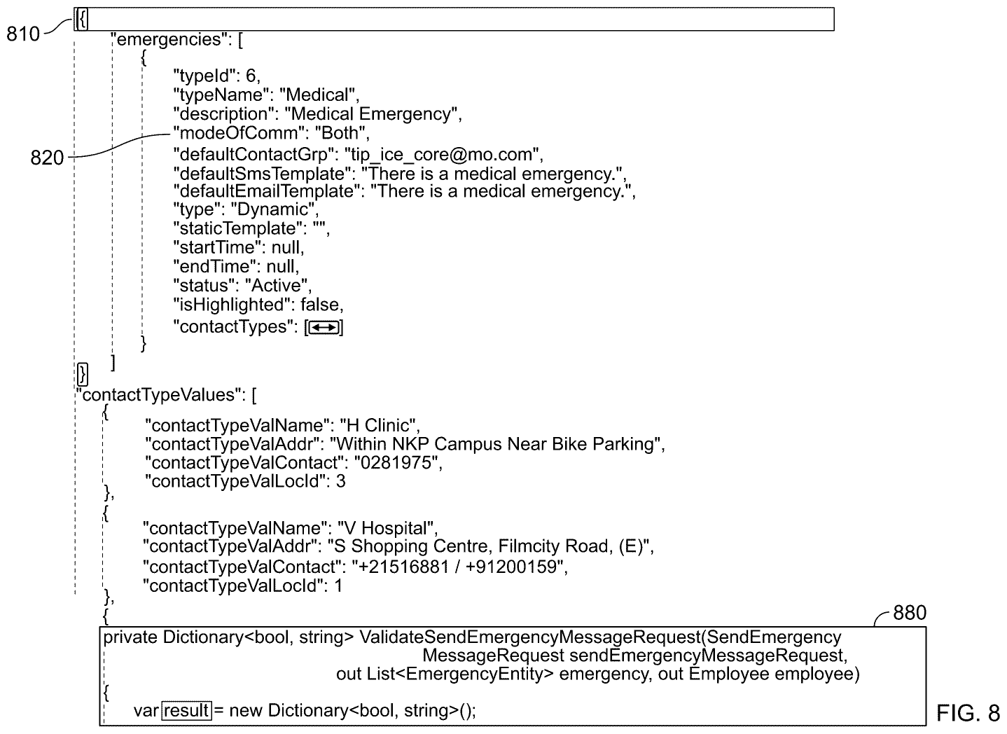

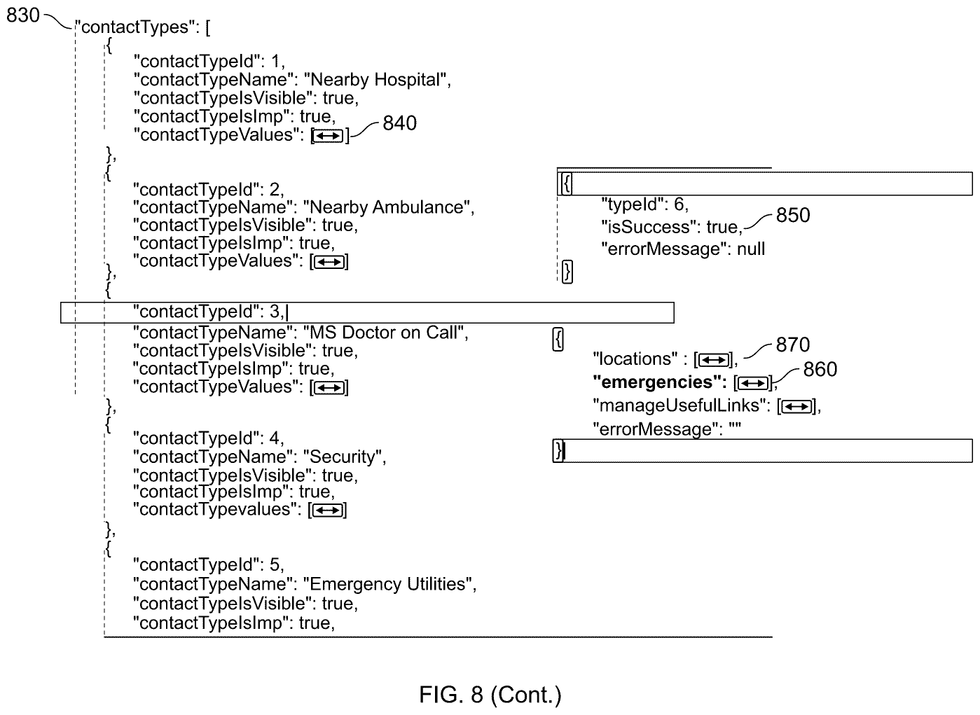

FIG. 8 shows example code and data structures for an emergency communication according to some embodiments of the invention.

In some embodiments, when an admin edits or adds an emergency template, a sequence of computerized actions may be performed or executed:
An endpoint may be called with a mode or template update request 810 which may sent by a UI and may be received by the ICE platform such as for example according to the description herein, using for example an API call->Admin/ManageEmergency (using, e.g., the HTTP POST method). In some embodiments, the request may include various fields describing the relevant emergency template or exchange type, such as for example a description of configurations or modes of communication 820, default emergency contacts or destinations, a field defining whether the template or type is static or dynamic (which may refer to permissions for other admins or users to edit or alter the template or type; for example, a “dynamic” field entry may allow users to modify, edit or alter the template, while a “static” field entry may not allow modifications by users other than the admin creating the template).
Embodiments may validate the request received from the admin's UI.
If validation is successful, embodiments may delete the existing saved emergency (if exists) from the relevant DB (which may be an emergency or exchange type data base, such as, e.g., ICE_EMERGENCY provided herein) and may save the updated or new emergency under the corresponding emergency or exchange type ID (which may include, e.g., generating a new ID which may be for example a serial number according to the formula: MAX ID+1).
After an emergency template is created or updated, embodiments may generate or fill contact types 830 for example according to the contents of request 810.
In some embodiments, each of contact types 830 may be unique within a given emergency template or exchange type, and each of contact types 830 may have or may be associated with a unique-identifier (which may be for example an integer).
In some embodiments, each of contact types 830 may have multiple contact type values 840, which may include, may refer to, or may be associated with a plurality of fields describing the relevant contact or contact types. For example, some nonlimiting contact type values may denote or specify the name of the emergency contact, its location (and/or an identifier associated with its location), a contact number or address, and the like.
Embodiments may save or store all the details in the relevant table or database, such as, e.g., the example ICE_EMERGENCY database described herein and may return a response to the admin's UI with a status or the template creation or update process, which may be, for example: isSuccess (true/false) 850.
Once the relevant details and the corresponding alert template are saved, the UI and/or page may be refreshed. For example, the UI may call endpoint API Call->Home/LoadData (HTTP GET), which may be received by the ICE platform such as for example according to the description herein, and embodiments may transmit and/or return all the emergency templates 860 and/or locations 870 existing in the DB to the UI. The UI may cache newly received information and may then use newly created/updated emergency.

In some embodiments, the exchange type comprises one or more of: an array data structure, a dictionary (which may be for example an associative array, map, or symbol table), and a tree data structure. Element 880 shows an example definition of a dictionary according to some embodiments of some embodiments of the invention—which may for example include Boolean and string variables or lists of variables which may specify, e.g., emergency contacts or entities, and/or modes of communication and/or various configurations such as for example described herein, and/or, whether the contacts or entities are enrolled or registered in the ICE platform or in a relevant WFM system (e.g., as a Boolean variables). Additional or alternative exchange type formats may be used in different embodiments.

Additional or alternative operations and protocols, as well as dedicated data structures and objects, may be used in different embodiments of the invention.

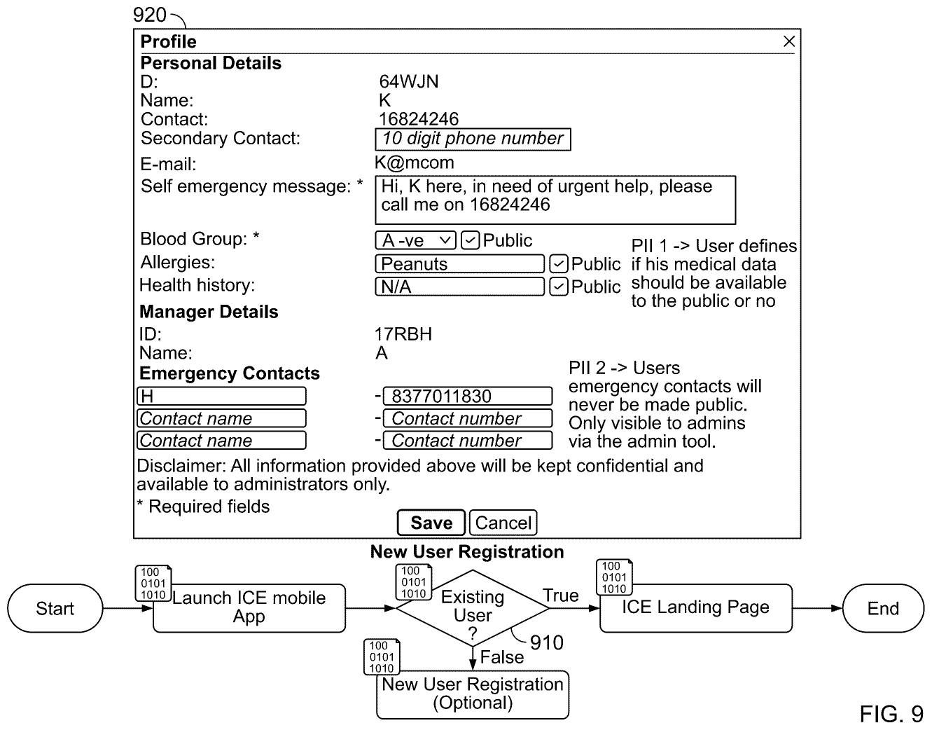

FIG. 9 shows an example user registration process according to some embodiments of the invention.

In some embodiments, when a new user logs into ICE (e.g., if the user is not an existing user, as in element 910)—the user may be redirected to a user profile page 920, where they may enter details to register with the ICE app. In some embodiments, users may always come back to profile page 920 (for example by clicking a button on the landing page or home page) for making edits to their entered information, which may include for example personal details, emergency contacts, and the like. When an existing or registered user opens ICE, they may be directed to a corresponding landing page or homepage on a dedicated UI, such as for example described and illustrated herein.

Additional or alternative user registration workflows and/or operations may be used in different embodiments.

In some embodiments, one or more of the data items to be exchanged includes: a health record, a blood type, and a username associated with one or more of the destination computing devices.

For example, once an emergency is raised for a given user or device, private information associated with the user—such as for example medical health records and specifications—may for example be extracted from DB and be sent or transmitted to the emergency contacts or destination devices specified by the relevant user. Example data structures or elements including, e.g., a health record, a blood type, and a username associated with destination computing devices are further provided herein, although different structures or elements may be used in different embodiments.

Some nonlimiting data structures that may be used in some embodiments of the invention are provided in Tables 1-5:

TABLE 1

| User/Employee Data | Data type |
|---|---|
| Id | varchar(6) |
| Name | varchar(100) |
| Contact | varchar(15) |
| SecondaryContact | varchar(15) |
| Email | varchar(120) |
| BloodGroup | varchar(10) |
| IsBloodGroupPublic | boolean |
| HealthHistory | varchar(max) |
| IsHealthHistoryPublic | boolean |
| AllergyHistory | varchar(max) |
| IsAllergyHistoryPublic | boolean |
| LocationId | integer |
| ManagerId | varchar(6) |
| IsAdmin | boolean |
| VolunteerFor | varchar(20) |
| EmergencyContactName1 | varchar(100) |
| EmergencyContactNo1 | varchar(15) |
| EmergencyContactName2 | varchar(100) |
| EmergencyContactNo2 | varchar(15) |
| EmergencyContactName3 | varchar(100) |
| EmergencyContactNo3 | varchar(15) |
| IsRegistered | boolean |
| DefaultEmergencyMessage | varchar(200) |

TABLE 2

| Location Data | Data type |
|---|---|
| Id | integer |
| Name | varchar(100) |
| Address | varchar(max) |

TABLE 3

| Emergency Data | Data type | Comments/examples |
|---|---|---|
| Id | integer | |
| TypeId | integer | |
| TypeName | varchar(20) | |
| Description | varchar(100) | |
| ModeOfComm | varchar(20) | SMS/email/both |
| DefaultContactGrp | varchar(max) | email IDs (comma separated), |
| | | emergency group owner |
| DefaultSmsTemplate | varchar(200) | |
| DefaultEmailTemplate | varchar(max) | |
| Type | varchar(20) | static/dynamic |
| StaticTemplate | varchar(max) | |
| StartTime | datetime | |
| EndTime | datetime | |
| Status | varchar(20) | active/inactive |
| ContactTypeId | integer | |
| ContactTypeName | varchar(20) | |
| ContactTypeIsVisible | boolean | |
| ContactTypeIsImp | boolean | |
| ContactTypeValName | varchar(100) | Array inside ContactType |
| ContactTypeValAddr | varchar(max) | |
| ContactTypeValContact | varchar(15) | |
| ContactTypeValLocId | integer | |

TABLE 4

| Transaction/ | |
|---|---|
| Communication Data | Data type |
| Id | integer |
| InitiatiorId | varchar(6) |
| ForId | varchar(6) |
| EmergencyContactName | varchar(100) |
| EmergencyContactDetails | varchar(100) |
| Message | varchar(max) |
| TimeStamp | datetime |
| LocationId | integer |
| ModeOfComm | varchar(20) |
| EmergencyTypeId | integer |
| EmergencyTypeName | varchar(20) |
| Status | varchar(20) |
| StatusDescription | varchar(100) |

TABLE 5

| Configuration | |
|---|---|
| Data | Data type |
| Id | integer |
| Key | varchar(max) |
| Value | varchar(max) |

For example, Table 1 may be or may represent data or information items (such as, e.g., first information items) which may for example be received by the server (and, e.g., stored in appropriate DB records) from a device or user (such as, e.g., a third entity) upon registering to, or upon being specified in, or entered into, ICE. In some embodiments, a data of information item such as, e.g., Table 1 or parts of it, may be used or included in data items to be exchanged, transmitted, or displayed by some embodiments of the invention (in one example, DefaultEmergencyMessage may be for example a data item to be exchanged which may, e.g., be extracted according to and/or from first data or information elements or items by some embodiments). Table 2 may for example be a data or information item describing locations or location information which may for example be linked or associated with a user and/or device and/or emergency contact (and may for example be included in the first and/or second information items such as, e.g., described herein). Table 3 may for example be a data or information item describing an exchange type or emergency template (which may be, e.g., included among second data or information items such as for example described herein), which may include a plurality of fields such as, e.g., modes of communication (“ModeOfComm”), default emergency contacts (“DefaultContactGrp”), default alert or message templates, various contact type related fields, a type or temple type (which may be, e.g., static or dynamic), and so forth. Table 4 may be for example a data or information item or record describing an emergency communication operation or protocol which has been initiated or performed by some embodiments, e.g., according to the nonlimiting examples provided herein. For example, some embodiments may monitor communications or messages received in response to the emergency raised, and store a plurality of data or information items in DB—such as, e.g., an identifier or serial number for the emergency raised, an identifier describing the initiator or sender computer, a “for” identifier or “forID” describing the user or device for which the emergency is raised, a status field (which may denote, for example, whether one of the emergency contacts has responded to the message or alert, and/or whether the emergency has been handled and is no longer relevant), and the like. Table 5 may for example be a data or information item describing configurations or configuration information according to some embodiments of the invention. For example, in accordance with the description herein, Table 5 may include information on relevant systems or platform such as for example URLs for integration with platforms such as for example Microsoft Teams and/or email server configurations like SMTP Host/Port. Using such a table may help ensuring, for example, that changes in integrated systems platforms and/or addresses may not require code changes and may only require configuration data modifications. Additional or alternative databases and/or database contents may be used in different embodiments.

According to some embodiments, some data elements or structures such as for example provided herein may be sent or transmitted over the network for example as JSON or .txt files, although additional or alternative formats may be used in different embodiments. As noted herein, some example data structures that may be used in some embodiments of the invention may be, e.g., arrays, trees, dictionaries and lists, although additional or alternative data or information items and data structures may be used in different embodiments.

Some embodiments may include an artificial intelligence (AI) based component. For example, some embodiments of the invention may include a chatbot, which may be built into ICE and may for example receive speech and/or data as inputs, and may for example provide a corresponding output for example in case the user, device, or entity raising the emergency requests guidance, assistance, or further instructions or commands for handling the emergency. In some embodiments, AI or chatbot outputs may for example be in text or voice formats, although additional or alternative formats may be used. In some nonlimiting example use cases, the AI or chatbot component may raise an emergency (e.g., in case technical difficulties prevents a sender device from doing so), may fetch or send YouTube links describing or showing a recommended course of action for handling the emergency, fetch or send details or contacts, e.g., of specialists known for handling related emergencies, output computer requests/commands and or code segments which may be inputted into relevant systems for resolving or mitigating the emergency and the like. In some embodiments, the AI or chatbot component may be or may include the ChatGPT 3.5 turbo large language model (LLM) and/or the Whisper speech recognition and transcription framework by OpenAI, and/or additional or alternative text to speech engines or platforms, which may for example be integrated into ICE using appropriate APIs. Additional or alternative AI or chatbot components or subcomponents may be used in different embodiments of the invention.

Some embodiments of the invention may include automatically performing one or more computer operations by one or more of the destination computing devices based on one or more of the transmitted data items.

For example, in some embodiments, the server sending emergency alerts or notifications may specify an executable file, and/or computerized commands or operations in the alert or notification. Destination computer systems or devices receiving an emergency alert from the server may be configured to perform the computer operation of automatically executing or running the executable code specified in the alert of message—which may correspond to or match an executable missing or not found on a computer device for which an emergency was raised (e.g., the third device). In another example, a destination device of a medical service provider (such as for example a hospital or emergency room) may be configured to automatically extract details from the emergency alert and/or from additional sources of information such as for example internal databases—e.g., based on information included in the alert or message (e.g., an identifier or name of the user for which an emergency is raised)—and may for example automatically schedule or record an appointment with a medical professional (e.g., a relevant specialist), and or create a record or text file indicating the user may be accepted to a given facility as a patient. In some embodiments, a destination device may reply to the emergency alert and may send a response or reply to the server and/or to the sender device and/or to the third device—for example confirming that the alert was received and that appropriate actions were taken, or for example noting that actions were not taken (e.g., in case a hospital or emergency room is full, and there is no room left for accepting the relevant user as a patient; or if a given destination computer system has no access to the executable file specified in the message or alert). Additional or alternative example automated actions may be included and performed by different embodiments of the invention.

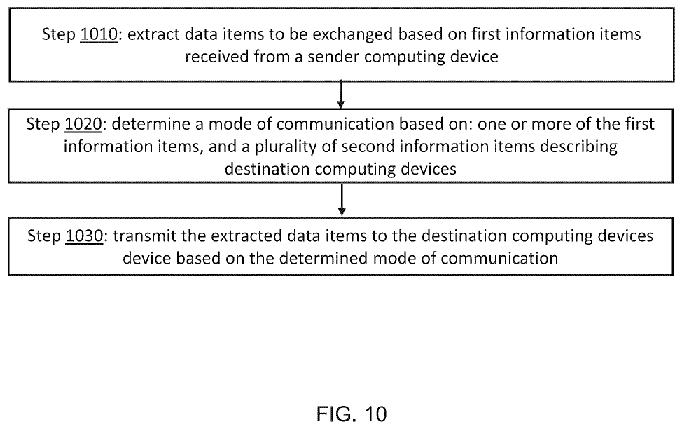

FIG. 10 shows an example method for performing exchanges of data over a computer network according to some embodiments of the invention.

In step 1010, embodiments may extract a plurality of data items to be exchanged based on one or more first information items received from a sender computing device (such as for example a raising of an emergency triggered by clicking on a button or icon on a UI of the sender device such as for example described herein; for example a device may receive user input indicating a mouse or other device has received a mouse click). Some embodiments may determine a mode of communication, for example based on: one or more of the first information items, and a plurality of second information items describing destination computing devices (which may for example be stored in DB of the server, and which, e.g., were originally received by the user or device for which the emergency is raised; step 1020). Some embodiments may transmit the extracted data items to the destination computing devices device (which may be, e.g., emergency contacts such as described herein) based on the determined mode of communication (which may be, e.g., email alerts, VoIP communications, and the like, such as described herein; step 1030).

Additional or alternative protocols and procedures for performing exchanges of data over a computer network may be used in different embodiments of the invention.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

1. A computerized method for performing exchanges of data over a computer network, the method comprising, by a server comprising a computer processor:
extracting from the server, by the processor, one or more data items to be exchanged based on one or more first information items, wherein one or more of the first information items are transmitted from a sender computing device, the transmitting of one or more of the first information items triggered by an artificial intelligence (AI) chatbot receiving input from the sender computing device, wherein the AI chatbot is integrated into an application deployed on the server;
determining, by the processor, a mode of communication selected from a group consisting of short message service (SMS), telephone call and email, the determining based on: one or more of the first information items transmitted from the sender computing device, and a plurality of second information items stored at the server, wherein one or more of the second information items describe one or more destination computing devices; wherein the extracted data items and one or more of the second information items were originally retrieved from a third computing device, the third computing device separate from the sender computing device and from the server, wherein an emergency is occurring for the third computing device at a time of the transmitting of one or more of the first information items from the sender computing device, wherein the extracted data items describe the emergency, and wherein the extracted data items are received from the third computing device upon registering to the application deployed on the server, and wherein the one or more first information items transmitted from the sender computing device comprise an identifier of the third computing device;
transmitting, by the processor, the extracted data items to one or more of the destination computing devices based on the determined mode of communication, the transmitted data items comprising an alert message;
granting the sender computing device access to one or more records describing the third computing device, the one or more records stored at the server, wherein the granting of the access is based on a location of the third computing device, wherein the granting of the access to the one or more records describing the third computing device is performed while private records of the third computing device are inaccessible to the sender computing device, the private records of the third computing device stored by the server; and
displaying one or more of the records to which access was granted on a graphical user interface (GUI) of the sender computing device.

2. (canceled)

3. The computerized method of claim 1, wherein the determining of a mode of communication and the transmitting of the extracted data items are performed based on an exchange type, wherein the exchange type is generated using a GUI of an administrator device.

4. The computerized method of claim 1, comprising displaying one or more of the second information items on the graphical user interface (GUI) of the sender computing device.

5. The computerized method of claim 3, wherein the exchange type comprises one or more of: an array data structure, a dictionary, and a tree data structure.

6. The computerized method of claim 1, wherein one or more of the destination computing devices device are associated with emergency contacts, and wherein one or more of the destination computing devices device are associated with medical care providers.

7. The computerized method of claim 1, wherein one or more of the data items to be exchanged includes: a health record, a blood type, and a username associated with one or more of the destination computing devices.

8. The computerized method of claim 1, wherein the transmitting of the extracted data items is initiated by clicking a button on the GUI of the sender device.

9. The computerized method of claim 1, comprising automatically performing one or more computer operations by one or more of the destination computing devices based on one or more of the transmitted data items.

10. A computerized system for performing exchanges of data over a computer network, the system comprising:
a computerized server comprising a processor and a memory, wherein the processor is to:
extract from the server one or more data items to be exchanged based on one or more first information items, wherein one or more of the first information items are transmitted from a sender computing device, the transmitting of one or more of the first information items triggered by an artificial intelligence (AI) chatbot receiving input from the sender computing device, wherein the AI chatbot is integrated into an application deployed on the server;
determine a mode of communication selected from a group consisting of short message service (SMS), telephone call and email, the determining based on: one or more of the first information items transmitted from the sender computing device, and a plurality of second information items stored at the server, wherein one or more of the second information items describe one or more destination computing devices; wherein the extracted data items and one or more of the second information items were originally retrieved from a third computing device, the third computing device separate from the sender computing device and from the server, wherein an emergency is occurring for the third computing device at a time of the transmitting of one or more of the first information items from the sender computing device, wherein the extracted data items describe the emergency, and wherein the extracted data items are received from the third computing device upon registering to the application deployed on the server, and wherein the one or more first information items received from the sender computing device comprise an identifier of the third computing device;
transmit the extracted data items to one or more of the destination computing devices based on the determined mode of communication, the transmitted data items comprising an alert message;
grant the sender computing device access to one or more records describing the third computing device, the one or more records stored at the server, wherein the granting of the access is based on a location of the third computing device, wherein the granting of the access to the one or more records describing the third computing device is performed while private records of the third computing device are inaccessible to the sender computing device, the private records of the third computing device stored by the server; and
display one or more of the records to which access was granted on a graphical user interface (GUI) of the sender computing device.

11. (canceled)

12. The computerized system of claim 10, wherein the determining of a mode of communication and the transmitting of the extracted data items are performed based on an exchange type, wherein the exchange type is generated using a GUI of an administrator device.

13. The computerized system of claim 10, wherein one or more of the second information items are displayed on the graphical user interface (GUI) of the sender device.

14. The computerized system of claim 12, wherein the exchange type comprises one or more of: an array data structure, a dictionary, and a tree data structure.

15. The computerized system of claim 10, wherein one or more of the destination computing devices device are associated with emergency contacts, and wherein one or more of the destination computing devices device are associated with medical care providers.

16. The computerized system of claim 10, wherein one or more of the data items to be exchanged includes: a health record, a blood type, and a username associated with one or more of the destination computing devices.

17. The computerized system of claim 10, wherein the transmitting of the extracted data items is initiated by clicking a button on the GUI of the sender device.

18. The computerized system of claim 10, wherein one or more of the destination computing devices are to automatically perform one or more computer operations based on one or more of the transmitted data items.

19. A computerized method for performing data transfers over a data network, the method comprising, by a server comprising a computer processor:
retrieve, by the processor, one or more data elements to be transferred based on one or more first data elements, wherein one or more of the first data elements are transmitted from an initiator computing device, the transmitting of one or more of the first data elements triggered by an artificial intelligence (AI) chatbot receiving input from the initiator computing device, wherein the AI chatbot is integrated into an application deployed on the server;
determining, by the processor, a mode of transfer selected from a group consisting of short message service (SMS), telephone call and email, the determining based on: one or more of the first data elements transmitted from the initiator computing device, and a plurality of second data elements stored at the server, wherein one or more of the second data elements describe one or more target computing devices; wherein the retrieved data elements and one or more of the second data elements were originally retrieved from an inaccessible computing device, the inaccessible computing device separate from the initiator computing device and from the server, wherein an emergency is occurring for the inaccessible computing device at a time of the transmitting of one or more of the first data elements from the initiator computing device, wherein the retrieved data elements describe the emergency, and wherein the retrieved data elements are received from the inaccessible computing device upon registering to the application deployed on the server, and wherein the one or more first data elements transmitted from the initiator computing device comprise an identifier of the inaccessible computing device;
transferring, by the processor, the retrieved data elements to one or more of the target computing devices based on the determined mode of transfer, the data elements comprising an alert message;
granting the initiator computing device access to one or more records describing the inaccessible computing device, the one or more records stored at the server, wherein the granting of the access is based on a location of the inaccessible computing device, wherein the granting of the access to the one or more records describing the inaccessible computing device is performed while private records of the inaccessible computing device are inaccessible to the initiator computing device, the private records of the inaccessible computing device stored by the server; and
displaying one or more of the records to which access was granted on a graphical interface of the initiator computing device.

20. (canceled)
